(19) United States
(12) Patent Application Publication
(10) Pub. No.: US 2005/0234198 A1
(43) Pub. Date: Oct. 20, 2005

(54) Heterophasic copolymer and metallocene catalyst system and method of producing the heterophasic copolymer using the metallocene catalyst system

(75) Inventors: Jun Tian, LaPorte, TX (US); William J. Gauthier, Houston, TX (US); Kenneth Paul Blackmon, Houston, TX (US); David J. Rauscher, Angleton, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 10/827,959

(22) Filed: Apr. 20, 2004

(51) Int. Cl. C08F 8/00

(52) U.S. Cl. 525/240

(57) ABSTRACT

Disclosed is a heterophasic polymer having a flowability over a broad range of xylene solubles content of the heterophasic polymer, a metallocene catalyst system (MCS) for producing such heterophasic polymer, and a method of producing such heterophasic polymer using the metallocene catalyst system. The MCS includes a support and a metallocene bound substantially throughout the support.

### BACKGROUND OF THE INVENTION

1. Field of the Invention

The present invention is directed to heterophasic polymers and to the production of the polymers. More specifically, the present invention is directed to the production of heterophasic polymers having substantially improved flowability characteristics and a process and catalyst for producing such polymers.

2. Background of the Art

It is well known that the incorporation of a rubber fraction into a polymer matrix, either via mechanical blending or by co-polymerization, improves the impact properties of the resulting polymers. Such polymers having improved impact characteristics are known as impact copolymers or as used herein, “ICP”. Such polymers also are heterophasic polymers in that two or more polymer phases are involved. The first phase is generally a homopolymer such as for example, a polypropylene homopolymer. The second phase generally is a rubber phase or simply “rubber” as used herein in reference to the background as well as to the present invention. Such rubber most often is an ethylene/propylene copolymer. In producing an ICP, the rubber phase generally attaches to a matrix of homopolymer along the outer surfaces of the homopolymer particles. As a result and due to the nature of the rubber, the resulting heterophasic polymer particles may be tacky and therefore the heterophasic particles do not flow readily but instead may “clump” or, in other words, form larger masses of heterophasic polymer particles stuck together. As a result of such clumping, the flowability and the resulting processability of the heterophasic polymers are impaired.

In producing ICPs, both conventional Ziegler-Natta and metallocene catalyst have been employed. With respect to the metallocene catalyst, generally, supported single site or metallocene catalysts systems referred to herein as “MCS”, are employed. However, the use of MCS can sometimes result in production of ICPs having poor flowability characteristics.

In view of the above referenced problems with respect to flowability of ICPs, there is a substantial need for MCS and methods of using such MCS, for the production of a heterophasic copolymer having improved handling properties particularly with respect to improved flowability.

### SUMMARY OF THE INVENTION

To address the above-discussed problem, the present invention, in one of its embodiments, is a heterophasic polymer having improved flowability. Such heterophasic polymer is one having a low xylene solubles content while having a consistent flowability such as to improve the handling and processing characteristics of heterophasic polymers. An embodiment of this heterophasic copolymer is material having a flowability within the range of from about 20 to about 80 grams/second. Such flowability is achieved while having a xylene soluble concentration of no greater than 15.0 wt. %.

In another embodiment, the present invention is an MCS comprising a supported metallocene catalyst component dispersed upon a support, the resulting MCS being capable of producing a heterophasic polymer having a flowability value within the range of from about 20 to about 80 grams/second. Generally, the xylene soluble content of the heterophasic polymer is no greater than 15.0 wt. %.

In still another embodiment, silica may be used to support one or more metallocene catalyst components. Such silica supported metallocene catalyst component under polymerization conditions produces a heterophasic polymer having the low xylene soluble concentration while also having a flowability value within the range of from about 20 to about 80 grams/second.

Another embodiment of the present invention includes the method of preparing the MCS. Such method includes the supporting of a metallocene catalyst component upon a silica support having a surface defining pore volume and surface area distribution to produce an MCS, such that upon utilization of the MCS to produce a heterophasic polymer, the resulting heterophasic polymer is one having a xylene soluble concentration no greater than 15.0 wt % and having a flowability value of from about 20 to about 80.

In still another embodiment, the present invention is a process for producing a heterophasic polymer comprising the use of an MCS in a two step or two zone polymerization process, to produce the heterophasic polymer, such process comprising polymerizing an olefin monomer in a first zone, which zone may be bulk or gas phase, to produce a homopolymer matrix of the olefin monomer, such homopolymer matrix being further polymerized in the presence of rubber precursor components in a second polymerization zone, such second zone polymerization being in the presence of the same or similar MCS as in the first zone, to produce a heterophasic polymer having a greater flowability and a lower xylene solubility content than such polymers produced by known processes. The first and second zones may be the same or different. The process may also have more than one first and/or second zones.

### BRIEF DESCRIPTION OF THE DRAWINGS

For a more complete understanding of the present invention, reference is now made to the following descriptions taken in conjunction with the accompanying figures, in which:

FIG. 1 illustrates BJH-DFT analysis results of pore volume distribution with respect to pore diameter for different silica support materials;

FIG. 2 illustrates BJH-DFT analysis results of surface area distribution with respect to pore diameter for different silica support materials;

FIG. 3 illustrates a particle size distribution analysis of the silica supports in hexanes;

FIG. 4 illustrates a particle size distribution analysis of the silica supports in acetone; and

FIG. 5 illustrates the pourability as a function of Xylene solubles levels.

### DETAILED DESCRIPTION OF INVENTION

The present invention as noted above, is in one of its embodiments, a heterophasic polymer composition having a flowability value of from about 20 to about 80 grams/second. Generally, such heterophasic polymer will have a xylene soluble content no greater than 15.0 wt. %. Such heterophasic polymer is one which may be produced using an MCS in which a particular silica is utilized to support a metallocene catalyst component, such MCS being further utilized to catalyze a multi step, such as a two step or zone polymerization process, such as a first and second zone wherein the first and second zone may be the same or different, in which an olefin monomer is polymerized in a first zone to produce a homopolymer matrix of such olefin monomer, such homopolymer then being further polymerized in a second step in the presence of rubber precursors to produce the heterophasic polymer having at least the above defined properties. There can also be more than one first and/or second zones.

The MCS utilized in producing the heterophasic polymer composition described above may be a single site catalyst, such as for example a metallocene catalyst which may be a bulky ligand transition metal compound generally represented by the formula:
[L]ₘMe[A]ₙ (1)
where L is a bulky ligand, A is a leaving group, Me is a transition metal and m and n are such that the total ligand valency corresponds to the transition metal valency.

The ligands L and A may be bridged to each other, and if two ligands L or A are present, they may be bridged. The metallocene compound may be full-sandwich compounds having two or more ligands L which, for example, may be cyclopentadienyl ligands (Cp) or cyclopentadiene derived ligands or half-sandwich compounds having one ligand L, which is a cylcopentadienyl ligand or cylcopentadienyl derived ligand. Other examples of ligands include fluorenyl (Flu), or indenyl (Ind), azulenyl or benzoindenyl groups and their substituted derivatives.

The transition metal atom may be a Group 4, 5, or 6 transition metal and/or a metal from the lanthanide and actinide series of the Periodic Chart of Elements. Zirconium, titanium, and hafnium are desirable. Other ligands may be bonded to the transition metal, such as a leaving group, such as but not limited to, halogens, hydrocarbyl, hydrogen or any other univalent anionic ligand. A bridged metallocene may, for example, be described by the general formula:
RCp(R′)Cp′(R″)MeQn (2)
wherein Me denotes a transition metal element and Cp and Cp′ each denote a cylcopentadienyl group, each being the same or different and which can be either substituted with R′ and R″ groups having from 1 to 20 carbons, respectively, or unsubstituted, the Q groups may be independently selected from an alkyl or other hydrocarbyl or a halogen group, n is a number and may be within the range of 1-3 and R is a structural bridge extending between the cyclopentadienyl rings. In another embodiment, there can be more than one R′ and/or R″ groups.

Examples of metallocene catalysts for producing isotactic polyolefins are disclosed in U.S. Pat. Nos. 4,794,096 and 4,975,403 which are incorporated by reference herein. These patents disclose chiral, stereo-rigid metallocenes that polymerize olefins to form isotactic polymers and are especially useful in the polymerization of highly isotactic polypropylene. Such isotactic polypropylene is important in that when it is introduced into the second gaseous reaction phase, the heterophasic polymers described herein are produced. Other examples of metallocene catalysts are disclosed in, for example, U.S. Pat. Nos. 4,530,914; 4,542,199; 4,769,910; 4,808,561; 4,871,705; 4,933,403; 4,937,299; 5,017,714; 5,026,798; 5,057,475; 5,120,867; 5,132,381; 5,155,180; 5,198,401; 5,278,119; 5,304,614; 5,324,800; 5,350,723; 5,391,790; 5,436,305; 5,510,502; 5,145,819; 5,243,001; 5,239,022; 5,329,033; 5,296,434; 5,276,208; 5,672,668; 5,304,614, 5,374,752; 5,510,502; 4,931,417; 5,532,396; 5,543,373; 6,100,214; 6,228,795; 6,124,230; 6,114,479; 6,117,955; 6,087,291; 6,140,432; 6,245,706; 6,194,341; and EP 549 900; 576 970; and 611 773; and WO 97/32906; 98/014585; 98/22486; and 00/12565, each of which is incorporated by reference herein in its entirety.

In certain embodiments, the metallocene catalyst is an iso-specific stereo rigid metallocene characterized by the formula:
R² bis(C₅₋ₙ(R¹)ₙ)MeQp (3)
wherein each (C₅₋ₙ(R¹)ₙ) is a substituted five membered ring such as a cyclopentadienyl ring; n may range from 1 to 4 so long as the number of sites available for substitution are not exceeded. Each R′ is the same or different and is a hydrogen or hydrocarbyl radical having 1-20 carbon atoms. R² is a structural bridge between the two (C₅₋ₙ(R¹)ₙ) rings imparting stereo-rigidity to the metallocene with the two (C₅₋ₙ(R¹)ₙ) rings being in a rac or meso configuration relative to Me. R² is selected from the group consisting of an alkylene radical having 1-20 carbon atoms, a silicon hydrocarbyl radical, a germanium hydrocarbyl radical, a phosphorus hydrocarbyl radical, a nitrogen hydrocarbyl radical, a boron hydrocarbyl radical, and an aluminum hydrocarbyl radical. Me is a group 4, 5, or 6 metal as designated in the Periodic Table of Elements; each Q may be independently selected from a hydrocarbyl radical having 1-20 carbon atoms or is a halogen; and 0≦p≦3. In one embodiment of the present invention, a common bridging group is Ph₂C or Ph₂Si— to R² wherein the R² group has 10 or 11 carbon atoms.

Advantageously, the (C₅(R¹)₄) groups are indenyl groups which are substituted or unsubstituted. In still other embodiments, the metallocene may be rac dimethylsilanediyl bis(2-methyl-4-phenyl indenyl)zirconium dichloride. In yet other advantageous embodiments metallocene may be selected from the group consisting of rac dimethylsilanediyl bis(2-methyl indenyl)zirconium dichloride, rac dimethylsilanediyl bis(2-methyl-4,5-benzoindenyl)zirconium dichloride and rac dimethylsilanediyl bis(2-methyl-4-(1-naphthyl) indenyl)zirconium dichloride.

In certain other embodiments, the R² bis(C₅₋ₙ(R¹)ₙ)MeQp formula above may be rewritten as follows:
R₂ bis(C₅₋ₘXₘ(R¹)ₙ)MeQp (4)
wherein the X may be a heteroatom selected from the group comprising boron (B), aluminum (A), nitrogen (N), phosphorous (P), oxygen (O), or sulfur (S) and M may be 0, 1 or 2. Additionally, the R¹ group may be the same if more than 1 and also may contain one or more heteroatoms of the group comprising B, Al, N, P, O or S and can be acyclic including heteroatoms or a ring structure such as a fused ring in which the heteroatoms may be incorporated as part of a fused ring system. Examples of such fused ring systems include thiophenes and thienyl groups in reference to sulfur, furan in reference to oxygen, pyrrole in reference to nitrogen and borato benzenes in reference to boron. The heteroatoms also may be used as side groups or bridging groups in catalyst of the Cp indenyl and fluorenyl type.

In still another embodiment, the metallocene catalyst incorporates a substituted cylcopentadienyl fluorenyl ligand structure and is characterized by the formula:
X(CpRₙR′ₘ)(FIR″_{n′})
wherein Cp is a cylcopentadienyl group; Fl is a fluorenyl group; X is a structural bridge between Cp and Fl imparting stereorigidity to the metallocene; R is a substituent on the cylcopentadienyl group; n is 1 or 2; R′ is a substituent on the cylcopentadienyl group at a position that is proximal to the bridge; m is 1 or 2; Each R″ is the same or different and is a hydrocarbyl group having from 1 to 20 carbon atoms with R″ being substituted on a nonproximal position on the fluorenyl group and at least one other R″ bein substituted at an opposed nonproximal position on the fluorenyl group; and n′ is 2 or 4. In an alternative embodiment, this metallocene catalyst can also include a heteroatom selected from the group IV transition metals and Vanadium. When the catalysts incorporates a heteroatom, it prefereably has the general formula:
X(CpRₙR′ₘ)(FIR″_{n′})(MQ₂)
wherein M is a heteroatom selected from the group IV transition metals and Vanadium and Q is a halogen or a C₁-C₄ alkyl group. Examples of such catalysts can be found in the following U.S. patents: U.S. Pat. Nos. 6,559,089, and 5,416,228, which are included herein by reference. The terms “support” or “carrier” are often used interchangeably and refer to any porous or non-porous support material which is often a porous support material, for example, talc, inorganic oxides or inorganic halides. The inorganic oxides and inorganic halides include those from Group 2, 3, 4, 5, 13 and 14. Typical examples of inorganic oxides include SiO₂, Al₂O₃, MgO, ZrO₂, TiO₂, Fe₂O, B₂O₂, CaO, ZnO, BaO, ThO₂ or mixed inorganic oxides such as SiO₂—MgO, SiO₂—Al₂O₃, SiO₂—TiO₂, SiO₂—V₂O₅, SiO₂—Cr₂O₃, SiO₂—TiO₂—MgO, zeolites, clays and such. Inorganic halides can be can be exemplified by MgCl₂. Desirably, the support of the MCS of the present invention is one having pore volume and surface area distribution such as to cause, when incorporated into the MCS which is used in the polymerization process, the production of the heterophasic polymer as defined hereinabove. Examples of supports include, but are not limited to silica, clay, alumina, MgCl₂, zirconia, talc, and kieselguhr. Silica supports are generally granular. The silica support may be substantially spheroidal, having an average particle size diameter ranging from about 1 to about 100 microns or about 20 to about 80 microns. One embodiment of the present invention, however, includes a silica support having an average particle size ranging from about 10 to about 33 microns or from about 10 to about 20 microns. This embodiment may be conducive to the production of smaller sized polymer fluffs having average diameters of less than about 600 microns yet still having a desirably high bulk density, for example, in one embodiment of at least about 0.40 g/cc, and in another embodiment of least about 0.44 g/cc. In another embodiment of the present invention, the polymer fluffs have a bulk density of from about 0.30 to about 0.55 g/cc.

Additionally, the supports of the present invention may have an average total pore volume of from about 1 to about 3.5 cc/g. In one embodiment of the present invention is from about 1.4 to about 1.8 cc/g. In still another embodiment, the pore volume is at least about 1.51 cc/g, and in another embodiment, at least about 1.79 cc/g. The maximum pore volume should, however, not exceed 500 ml/g. In many embodiments of the present invention, the support has an average total surface area of at least about 273 m²/g or in other embodiments at least about 311 m²/g.

In other embodiments, the MCS includes a silica support having a peak pore volume (see FIG. 2) of greater than about 0.12 mL/g or greater than about 0.137 mL/g at a pore diameter of greater than about 240 Angstroms but no greater than 320 Angstroms. At the peak pore volume, the pore diameter ranges between about 240 Angstroms and about 440 Angstroms in most embodiments of the present invention. In other advantageous embodiments, the support has a peak pore volume of at least about 0.12 mL/g at a pore diameter between about 270 Angstroms and about 330 Angstroms.

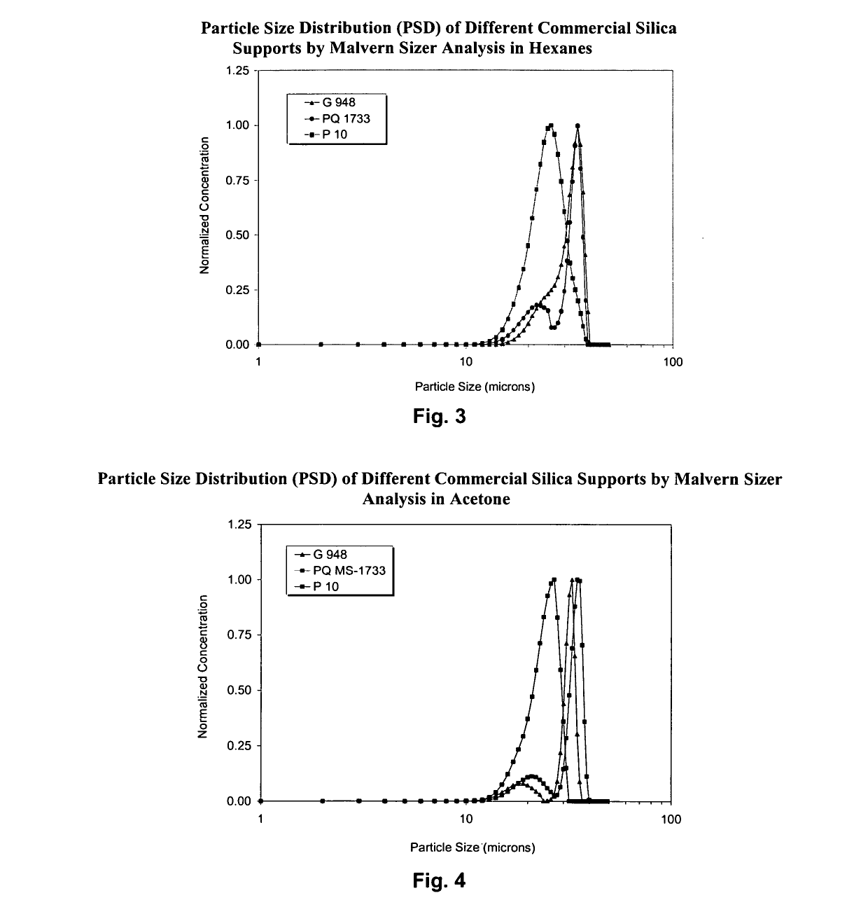

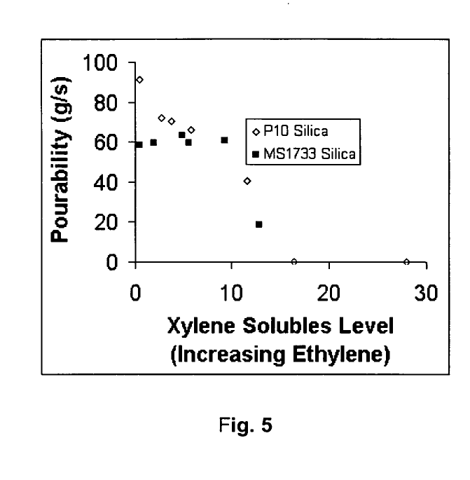

In other embodiments, the silica support of the MCS is one having a peak surface area (see FIG. 3) of greater than about 16 m²/g, but no greater than 32 m²/g. In most embodiments of the present invention, the peak surface area is greater than 18 m²/g, but no greater than 24 m²/g. at a pore diameter of greater than about 240 Angstroms. In some embodiments, however, at the peak surface area of from about 8 to about 24 m²/g, the pore diameter ranges between about 240 Angstroms and about 400 Angstroms.

The terms “pore volume” and “surface area” as used herein, refer, respectively, to the pore volume and surface area parameters of the supports, and are parameters measured for the entire range of pore diameters present in a particular support. These parameters may be expressed as a total average pore volume or total average surface area, respectively, for example, as measured by conventional gas absorption/desorption techniques and using the Brunauer, Emmett and Teller model (BET).

The distributions of pore volume and surface area, over the range of pore diameters present in the support material, may also be measured using conventional methods, such as the Barrett-Joyner-Halenda (BJH) method, and Oliver-Conklin Density Function Theory (DFT). Such data may be presented as a maximum or peak pore volume or maximum or peak surface area at a particular range of pore diameters. As further explained herein, supports having different pore volume and surface area distributions, also may have different metallocene catalyst and activator supporting mechanisms, and polymerization behavior.

Generally, in the production of the MCSs of the present invention, an activator is used in conjunction with the metallocene catalyst and support. The term activator, as used herein, refers to a compound or component, or combination of compounds or components, capable of enhancing the ability of one or more metallocene catalysts to polymerize olefins to polyolefins either as homopolymers, copolymers or other heterophasic polymers. A particularly useful class of activators is based on organo-aluminum compounds, which may take the form of an alumoxane, such as MAO or a modified alkyl-aluminoxane compound. Alumoxane (also referred to as aluminoxane) is an oligomeric or polymeric aluminum oxy compound containing chains of alternating aluminum and oxygen atoms, whereby the aluminum carries a substituent, such as, for example, an alkyl group.

Alumoxanes are typically the reaction products of water and an aluminum alkyl, which in addition to an alkyl group may contain halide or alkoxide groups. Reacting several different aluminum alkyl compounds, for example, trimethylaluminum (TMA) and tri-isobutyl aluminum, with a correct stoichiometry of water yields so-called modified or mixed alumoxane activators. Other non-hydrolytic routes for the production of activators are well known to those of ordinary skill in the art. Alumoxanes useful with the present invention are MAO and MAO modified with minor amounts of other higher alkyl groups such as isobutyl. Alumoxanes generally contain minor to substantial amounts of starting aluminum alkyl compound(s).

There are a variety of methods for preparing alumoxane, non-limiting examples of which are described in U.S. Pat. Nos. 4,665,208, 4,952,540, 5,091,352, 5,206,199, 5,204,419, 4,874,734, 4,924,018, 4,908,463, 4,968,827, 5,308,815, 5,329,032, 5,248,801, 5,235,081, 5,103,031 and EP-A-0 561 476, EP 0 279 586, EP-A-0 594 218 and WO 94/10180, each fully incorporated herein by reference. As used herein, unless otherwise stated, “solution” refers to any mixture including suspensions.

Ionizing activators may also be used to activate metallocenes. These activators are neutral or ionic, or organo-boron compounds, such as tri(n-butyl)ammonium tetrakis (pentaflurophenyl)borate, which ionize the neutral metallocene compound. Such ionizing compounds may contain an active proton, or some other cation associated with, but not coordinated or only loosely coordinated to, the remaining ion of the ionizing compound. Combinations of activators may also be used, for example, alumoxane and ionizing activators in combinations, see e.g., WO 94/07928, incorporated herein by reference.

Descriptions of ionic catalysts for coordination polymerization comprised of metallocene cations activated by non-coordinating anions appear in EP-A-0 277 003, EP-A-0 277 004 and U.S. Pat. No. 5,198,401 and WO-A-92/00333 (incorporated herein by reference). These teach a method of preparation wherein metallocenes, such as bis Cp and monoCp, are protonated by an anion precursor such that an alkyl/hydride group is abstracted from a transition metal to make it both cationic and charge-balanced by the non-coordinating anion. Suitable ionic salts include tetrakis-substituted borate or aluminum salts having fluorinated aryl-constituents such as phenyl, biphenyl and naphthyl.

The term non-coordinating anion (NCA) as used herein refers to an anion that either does not coordinate to the cation or that is only weakly coordinated to the cation, thereby remaining sufficiently labile to be displaced by a neutral Lewis base. “Compatible” non-coordinating anions are those which are not degraded to neutrality when the initially formed complex decomposes. Further, the anion may not transfer an anionic substituent or fragment to the cation so as to cause it to form a neutral four coordinate metallocene compound and a neutral by-product from the anion.

The use of ionizing ionic compounds not containing an active proton but capable of producing both the active metallocene cation and a non-coordinating anion, are also known. See e.g., EP-A-0 426 637 and EP-A-0 573 403 (incorporated herein by reference). An additional method of making the ionic catalysts uses ionizing anion precursors which are initially neutral Lewis acids but form the cation and anion upon ionizing reaction with the metallocene compounds, for example, the use of tris(pentafluorophenyl) borane, see EP-A-0 520 732 (incorporated herein by reference). Ionic catalysts for addition polymerization can also be prepared by oxidation of the metal centers of transition metal compounds by anion precursors containing metallic oxidizing groups along with the anion groups, see EP-A-0 495 375 (incorporated herein by reference).

Where the metal ligands include halogen moieties, for example, bis-cyclopentadienyl zirconium dichloride, that are not capable of ionizing abstraction under standard conditions, they can be converted via known alkylation reactions with organometallic compounds, such as lithium or aluminum hydrides or alkyls, alkylalumoxanes, Grignard reagents, and other reaction well know to those skilled in the art. See EP-A-O 500 944 and EP-Al-0 570 982 (incorporated herein by reference) for in situ processes describing the reaction of alkyl aluminum compounds with dihalo-substituted metallocene compounds prior to or with the addition of activating anionic compounds.

Methods for supporting ionic catalysts comprising metallocene cations and NCA are described in U.S. Pat. Nos. 5,643,847, 6,143,686 and 6,228,795 (all fully incorporated herein by reference). When using the support composition, these NCA support methods generally include using neutral anion precursors that are sufficiently strong Lewis acids to react with the hydroxyl reactive functionalities present on the silica surface such that the Lewis acid becomes covalently bound.

Additionally, when the activator for the metallocene supported catalyst composition is a NCA, the NCA is usually first added to the support composition followed by the addition of the metallocene. When the activator is MAO, the MAO and metallocene may be dissolved together in solution. The support is then contacted with the MAO/metallocene solution. Other methods and order of addition will be apparent to those skilled in the art.

Another aspect of the present invention is directed to a method for the preparation of an MCS. The process includes providing an activator modified support having a metallocene catalyst dispersed substantially throughout the support to form the MCS. The support is one which when incorporated into an MCS will result in an MCS capable of producing a heterophasic polymer having a flowability value generally, while having a xylene soluble content as discussed elsewhere herein.

The process for preparing the MCS may include special handling conditions designed to avoid damaging the highly porous supports, such as for example silica, of the present invention. For example, in certain embodiments, the process step of combining the activator with the support may include mixing under stirring conditions such as to avoid damaging the support, an activator with the support such that the activator is dispersed substantially throughout the pores of the support up to the pore volume of the support. For example, MAO may be added to a toluene/silica slurry while gently stirring, tumbling, agitating, or the like, again, to avoid damage to the structure of the silica support, during the period when MAO is allowed to interact and attach throughout the silica. Then, the metallocene catalyst may be attached to the activator impregnated silica support to form the MCS.

In the process of the present invention, an olefin monomer is brought into contact with the MCS under polymerization conditions in a first step to produce a homopolymer of such olefin monomer. The homopolymer of the present invention is substantially isotactic, often having an at least 98% meso dyad content wherein, for the purposes of the present invention, a meso dyad content refers to two inserted monomer units along a polymer chain having the same relative configuration. Such a homopolymer generally will be one having a melt flow (MF) of 10 and a bulk density of 0.35 g/cc. The homopolymer is then brought into contact with rubber precursors in accordance with the present invention, in the presence of an MCS in a second reaction step whereby the rubber precursors are polymerized in the presence of the homopolymer matrix to form a rubber containing heterophasic polymer. The MCS may be the same in both polymerization steps or it may be different.

With reference to the olefin monomer which may be polymerized in a first reaction step to produce the homopolymer matrix, such a monomer generally includes an alpha olefin having between 3 and 20 carbon atoms. Propylene is an example of an olefin monomer useful in the first reaction step of preparing the heterophasic polymers of the present invention. In a typical embodiment of the present invention, propylene and hydrogen are reacted in the first reactor and then going into a second reactor containing ethylene, propylene and hydrogen. Occasionally, a small amount of ethylene is added in the first reactor to produce a mini-random copolymer for purposes of reducing flexural modulus and improving impact performance.

Generally, in the process of the present invention, the monomer may be contacted with the MCS in a first reaction zone including a reaction temperature of about 50° C. to about 75° C., a reaction period between about 15 minutes and about 4 hours, and in which the reaction zone further includes H₂ and triethylaluminum (TEA). In an embodiment of the present invention, the H₂ may range from about 0 to about 500 ppm mM or about 0 to about 300 ppm. The TEA may range from about 10 ppm to 300 ppm, and be, for example, about 100 ppm. A hydrocarbon diluent can also be used in the reaction medium. For example, a diluent such as hexanes, isobutane, and the like can be used with the process of the present invention.

The process for polymerization of olefin monomers to produce the rubber fraction includes one or more olefin co-monomers such as for example, ethylene and propylene. Examples of other co-monomers include, but are not limited to: 1-butene, 4-methylpentene, isobutene, 1-hexene, 1-octene and mixtures thereof. The co-monomers may be contacted with the MCS at a reaction temperature of about 60 to 75° C., a reaction period of about 15 min to about 4 h. The co-monomers may be supplied as fluids, in ratios of co-monomers:P ranging from about 30:70 to about 70:30, but usually at approximately 50:50. The total co-monomer gas flow ranges used in a 2L reactor range from about 2 L/min to about 15 L/min or about 6 L/min to about 10 L/min. H₂ may be supplied at rates ranging from about 0 to about 100 cc/min or about 80 cc/min. The reaction step's pressure may range from about from about 50 psi (345 kPa) to about 100 (690 kPa) psi, and be, for example about 80 psi (550 kPa).

The flow rates, etc. as described immediately above are for lab scale polymerizations. In a commercial polyolefin production line, the flows would be considerably higher and quantities produced also much higher. While the process of the present invention can be used on a laboratory or pilot plant scale, it is designed for and can be used with a commercial production facility wherein tons rather than pounds of polymer are prepared.

The heterophasic polymers of the present invention can be produced in multiple reactors, for example, two or three, operated in series. In one embodiment, the homopolymer is produced in a first polymerization reaction zone. The rubber fraction is then polymerized in a second reaction zone or step in a second reactor and in the presence of the homopolymer of the first reaction zone.

As used herein the term reaction step or zone is defined as that portion of the polymerization process during which one component of the heterophasic polymer, such as the homopolymer matrix, is produced. One or multiple reactors may be used for each reaction step, for example, loop, gas phase (vertical or horizontal) reactors, or combinations thereof. Hydrogen gas (H₂) may be added to one or both reaction steps to control molecular weight (MW) molecular weight distribution (MWD), intrinsic viscosity (IV) and MF. The use of H₂ for such purposes is well known to those skilled in the art.

The reaction zones hereinabove referenced, as previously noted, may be operated using the same or different polymerization methods and modes. For example, each zone may be operated in liquid, slurry, solution, suspension, bulk or gas phase or by mass polymerization and may be operated in a batch or continuous mode. In many embodiments of the present invention, the operation of the first reaction zone is done using a liquid or bulk phase, and the operation of the second reaction zone is done in gas phase. As used herein, reference to liquid phase polymerization, unless otherwise defined, is intended to include a liquid slurry phase.

The heterophasic polymers produced using the MCSs including the silica support of the present invention, can have a median particle diameter of from about 500 microns to about 4,000 microns. In another embodiment, the median particle diameter can be from about 1,000 microns to about 3,000 microns. The median particle diameter of the rubber fractions can be within the range of 0.01 to 100 microns.

These heterophasic polymers normally have a melt flow that may be adjusted depending on the desired end use, but will be typically within the range of about 0.1 to 100 g/10 min or about 1 to about 100 g/10 min. In other embodiments, the heterophasic polymer has a melting temperature (Tm) of about 130 to about 165° C. or from about 145 to about 155° C. or even from about 149 to about 151° C.

Although the homopolymer matrix produced in the first reaction step may be a homopolymer of, for example propylene, in certain embodiments, small amounts of a co-monomer, may be incorporated into the first reaction zone to obtain particular properties in the resulting first reaction zone polymer matrix. If co-monomer is added, the amount generally may be less than ten weight percent (10 wt %) of the primary monomer. However, such co-monomer, if present, will be present in an amount of less than about one weight percent (1 wt %). Such co-monomer may include ethylene and any ethylenically unsaturated hydrocarbons having from 2 to 20 carbon atoms, for example, 1-butene, 4-methyl-1-pentene, 1-hexene or 1-octene. The end result of the use of such co-monomers may be a copolymer matrix product with lower stiffness, but with some gain in impact strength compared to a homopolymer.

The homopolymer produced in the first reaction step using the MCS including the silica support of the present invention, in most embodiments has a narrow molecular weight distribution, MWDcry, i.e., lower than 4.0 or lower than 3.0. MWDcry is defined as the molecular weight distribution Mw/Mn of the amorphous “rubber” phase of the polymer. These molecular weight distributions are obtained in the absence of visbreaking, such as by the addition of peroxide, or other post reactor treatment designed to reduce molecular weight. The homopolymer of the first reaction step may have a weight average molecular weight of at least 100,000 or at least 200,000 and a melting point (MP) of at least about 145° C. or at least about 150° C. In one embodiment of the present invention, the homopolymer of the first reaction step has a melting temperature of from about 152° C. to about 155° C.

The rubber employed in the second reaction step may be a copolymer comprising a lower molecular weight olefin component, for example, ethylene, and a higher molecular weight component, for example, propylene. Either the lower or higher molecular weight olefin may include ethylenically unsaturated hydrocarbons having from 2 to 20 carbon atoms. Other combinations of lower and higher MW components comprising the copolymer, however, may be used depending on the particular product properties desired. For example, propylene/1-butene, propylene/1-hexene, 1-hexene/1-octene, or ethylene/1-butene may be used. Additionally, the copolymer of the second reaction step may be a terpolymer such as propylene/ethylene/hexene-1 terpolymers.

In the practice of the present invention, the rubber component of the copolymer includes is about 8 to about 15.0 wt % of the heterophasic polymer, and is often about 10 to about 12 wt %. The co-monomer ratio (low MW component:high MW component) of the copolymer is generally in the range of from about 20:80 to about 80:20 or from about 40:60 to about 80:20 or about 50:50. As an example, the lower molecular weight olefin co-monomer may include at least about 20 mol % ethylene or from about 40 mol % to about 80 mol % of the co-monomer mix. The ratio of co-monomers in the rubber fraction may be adjusted to provide the specific properties of ICP that are desired depending upon the specific anticipated usage thereof.

The rubber fraction can have a narrow molecular weight distribution (MWDrub-M_{w}/Mₙ) of lower than about 5.0, lower than about 4.0, or even lower than about 3.5. In some embodiments of the present invention, the rubber fraction of the copolymer can have a MWDrub of lower than 3.0, 2.5 or even lower. These molecular weight distributions may be obtained in the absence of visbreaking, peroxide treatment or other post reactor treatment designed to reduce molecular weight. The rubber fraction may have a weight average molecular weight of at least 100,000, at least 150,000, or at least 200,000.

The rubber fraction can have an intrinsic viscosity (IV) of greater than about 1 dL/g or greater than about 2.00 dL/g. The term “IV” as used herein refers to the viscosity of a solution of polymer, such as the rubber fraction, in a given solvent at a given temperature, when the polymer composition is at infinite dilution. Conventional methodology, such as ASTM D 1601-78, may be used to measure IV for a series of concentrations of the polymer in a suitable solvent, for example, decalin, and temperature, for example about 135° C.

The rubber fraction of the heterophasic polymer of the present invention can have a low crystallinity that may be provided by an MCS having a reaction ratio for lower and higher molecular weight component of less than about 5:1, or, for example, 1:1, of MCS to co-monomers. In certain embodiments, the heterophasic polymer can have less than about 10, less than about 7, or less than about 4 consecutive sequences of lower molecular weight co-monomer, for example, ethylene. Similarly, the heterophasic polymer may have less than about 15, less than about 12, or less than about 5 consecutive sequences of higher molecular weight co-monomer, for example, propylene.

Having described the present invention, it is believed that the same will become even more apparent by reference to the following experiments. It will be appreciated that the experiments are presented solely for the purpose of illustration and should not be construed as limiting the invention. For example, although the experiments described below may be carried out in laboratory or pilot plant settings, one skilled in the art could adjust specific numbers, dimensions and quantities up to appropriate values for a full scale production plant.

### EXAMPLES

The following example is provided to illustrate the present invention. It is not, however, intended to be, nor should it be construed, as being limitative of the scope of the invention in any way.

To illustrate the present invention, three commercially available silica supports are selected for testing and comparison with respect to their use in supporting metallocene catalysts. These are (1) a silica obtained from PQ Corporation of Valley Forge, Pa. and having a product number MS-1733, (2) a silica obtained from Fuji Silysia Chemical Company, Ltd. of Japan and having a product number P-10, and (3) a silica of Grace Davison Chemicals of Columbia, Md. and identified as Sylopol 948 or simply as G-948.

The average particle size of the three silica supports is determined using a conventional Malvern sizer and conventional methodology using hexane or acetone as the carrier. The analysis of the pore characteristics (i.e., pore volume, surface area, pore diameter and distributions) is conducted on an ASAP 2400 (Micromeritics Instrument Corp., Norcross, Ga.), using nitrogen as the adsorbate for the conventional measurements of adsorption and desorption isotherms. The data is used for the calculation, using the BET model, of total surface area, total pore volume and average pore diameter. In addition, the data are analyzed to determine, using the BJH method and DFT, the pore volume and surface area distributions.

TABLE 1 summarizes the total surface area, total pore volume and average pore diameter and average particle size for the three supports using data from a Malvern sizer using hexane as the solvent. The average pore diameter is calculated assuming a cylindrical pore structure, circular in cross section. The average particle size (D50) is based on the pore volume data. The total surface area, pore volume and average particle size of the MS-1733 support are substantially higher than the analogous values for the G-948 and P-10 supports.

The pore volume and surface area distributions for the three silica supports are measured. The BJH method is used for calculating these distributions, based on a model of the adsorbent (silica carrier) as a collection of cylindrical pores. The calculation accounts for capillary condensation in the pores using the classical Kelvin equation (free energy of surface tension), which in turn assumes a hemispherical liquid-vapor meniscus and a well-defined surface tension. The calculation also incorporates thinning of the adsorbed layer through the use of a reference isotherm, so that the Kelvin equation is only applied to the “core” fluid.

In addition, the DFT is used to make distribution calculations using conventional mathematical, statistical, and numerical techniques for interpreting data from the ASAP 2400 instruments. The DFT offers a unified approach to analyzing the entire adsorption isotherm from 4 to 1000 Å in diameter. All pores, from the smallest to the largest, are reported using a single data reduction technique, termed as the BJH-DFT reduction, thereby providing a broad picture of adsorption activity.

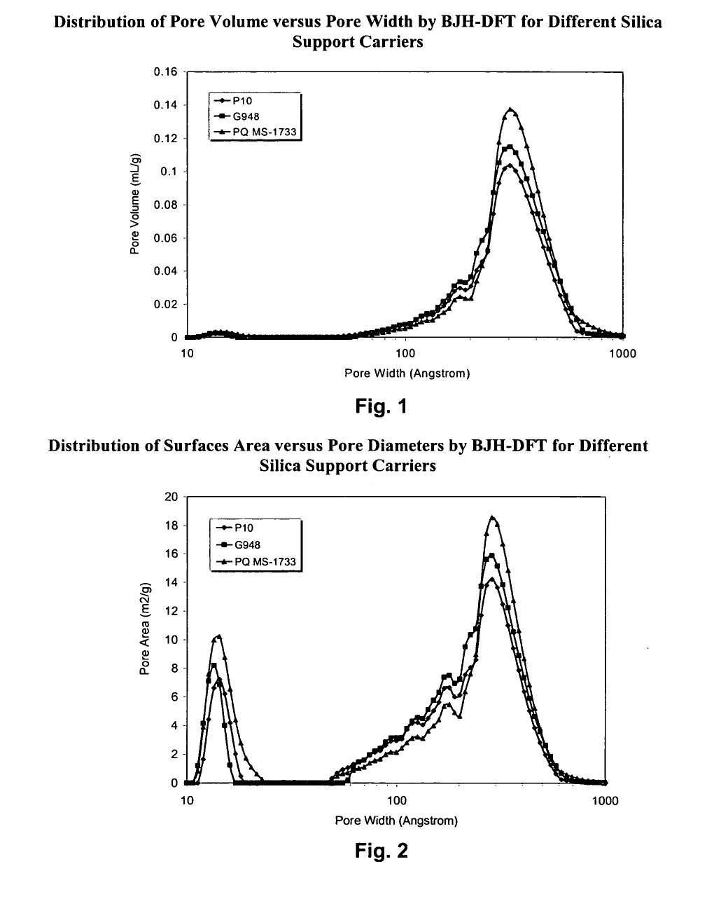

As noted above, TABLE 1 summarizes the surface area, pore volume, average pore diameter and average particle size for the three silica supports. FIG. 1 illustrates comparative BJH-DFT analysis results of pore volume distribution with respect to pore diameter for MS-1733 silica, P-10 and G-948 silica and also, illustrates BJH-DFT analysis results of surface area distribution with respect to pore diameter for the three supports. Peak pore volumes and surface areas both occur at about 300 Angstroms.

TABLE 1

| | Surface Area | Pore | Average Pore | Avg. Particle |
|---|---|---|---|---|
| Support | (m²/g) | Volume (mL/g) | Diameter (Å) | Size (μm) |
| MS-1733 | ˜311 | ˜1.79 | ˜230 | ˜74 |
| P10 | ˜270 | ˜1.5 | ˜222 | ˜20 |
| G-948 | ˜272 | ˜1.71 | ˜253 | ˜55 |

As the next step in illustrating the present invention, the three silica supports are loaded with an activator. The activator used is MAO from the Albemarle Corp. of Baton Rouge, La. The loading of activator into the MS-1733 support, and for comparative purposes, the P-10 and G948 supports is measured. Two separate runs, (1) and (2), are carried out for the MS-1733 and G-948 supports while the P-10 is the subject of only one run. The reaction between the silica supports and the MAO is conducted as described in U.S. patent application Ser. Nos. 09/782,752 and 09/782,753 to Gauthier et al., incorporated herein by reference. All the silica supports are dried at 150° C. for 12 hours under a nitrogen flow of 6 mL/min. The grafting of MAO to the silica in toluene is carried out at 115° C. for 4 hours then filtered to remove soluble Al. The starting concentration ratios of MAO:silica are depicted in TABLE 2 below (“Start”). From preliminary experiments, it is known that increasing the starting ratio of MAO:silica above 0.65 for the P-10 and G948 supports does not increase the final amount of MAO loaded onto the supports. After grafting, work-ups included filtration and several toluene washes of the MAO-modified silica supports to remove excess Al species. The MAO-modified silica supports are then measured for MAO loading via Aluminum analysis by conventional means. The final amounts of MAO grafting achieved for the three MAO-modified silicas, as shown in TABLE 2 (“Final”), are at least about 22.6% higher for MS-1733 than for P-10 and G-948.

A particle size distribution analysis of the MAO-modified silica supports is performed using the above-mentioned Malvern Sizer in acetone. The analysis is illustrated in FIG. 3. The MAO-modified MS-1733 has the largest peak particle size centered at about 35 microns, while MAO-modified G-948 and P-10 had a peak particle sizes centered at about 30 microns and about 27 microns, respectively.

Also shown in TABLE 2 is the catalytic activity (CA) for producing the homopolymer phase, of an MCS prepared in accordance with the present invention using the above-described silica supports. In preparing the MCS, a metallocene catalyst, rac dimethylsilanediyl bis(2-methyl-4-phenyl indenyl)zirconium dichloride, is loaded into the MAO-modified silica prepared as described above. To prepare this MCS, about 2.5 g of MAO-modified silica is mixed with 25 ml of toluene at room temperature under nitrogen. The metallocene (about 25 mg; designated as 2 wt % metallocene loading) in about 10 ml of toluene is added to the MAO-modified silica under gentle stirring. The mixture is allowed to react for about 2 hours at room temperature (about 22° C.). The MCS is then filtered and washed three times with toluene (3×10 mL) and three times with hexane (3×10 mL) under nitrogen at room temperature. After drying at room temperature under vacuum to a constant weight, MCS is diluted into about 25 g of mineral oil and then isolated as a slurry.

The catalytic activity (CA) of the MCS for the production of the homopolymer is measured following the methodology described in U.S. patent application Ser. Nos. 09/782,752 and 09/782,753 to Gauthier et al. Briefly, unless otherwise indicated, the polymerization is carried out in bulk phase in a conventional 4 L Autoclave Zipperclave reactor chamber, in the presence of about 24 millimoles H2, about 1300 g propylene, and about 90 mg of TEA, at about 67° C. for one hour. For runs (1) and (2) using MS-1733, about 15 mg and about 20 mg of MCS are used. All measurements conducted using G-948 and P-10 are conducted under the same conditions, but using about 25 mg of MCS. Catalytic activity is expressed as g of polypropylene produced per g of MCS per hr (gig/hr). As illustrated in TABLE 2, MCSs prepared from MS-1733 had catalytic activities for the production of the homopolymer phase, at least about 22% higher than the catalytic activity for metallocene catalyst systems prepared from G-948 and at least about 96% higher than the metallocene catalyst system prepared from P-10 silica.

The results of the MAO loading and catalytic activity for the three silica support materials are summarized in the following TABLE 2.

TABLE 2

| | MAO:silica (wt:wt) | | |
|---|---|---|---|
| Support | Start | Final | CA (g/g/hr) |
| MS-1733(1) | ˜1.00:1 | ˜0.76:1 | ˜22,900 |
| MS-1733(2) | ˜1.00:1 | ˜0.76:1 | ˜23,500 |
| G-948 (1) | ˜0.65:1 | ˜0.62:1 | ˜18,500 |
| G-948 (2) | ˜0.65:1 | ˜0.62:1 | ˜18,800 |
| P-10 (1) | ˜0.60:1 | ˜0.56:1 | ˜11,700 |

Samples of the homopolymer produced substantially as described above but using the three different silica support materials, are tested for certain characteristics as described below. Again, two separate samples of homopolymers are produced and characterized for each of the MS-1733 and the G-948 supported MCS with only one sample of homopolymer produced using the P-10 supported MCS is characterized. Polymer melt flow (MF) is recorded on a Tinius-Olsen Extrusion Plastometer at 230° C. with a 2.16 Kg mass. Polymer powder is stabilized with approximately 1 mg of 2,6-ditert-butyl-4-methylphenol (BHT). Bulk density (BD) measurements are conducted by weighing the unpacked contents of a 100 mL graduated cylinder containing the polymer powder. The polymer fluff particle size distribution is measured using a conventional sieve shaker.

TABLE 3 shows the MF and bulk density (BD) properties of the homopolymer produced using each of the silica supports, under the conditions used to produce the MCS described above. For all of the MCSs, the homopolymer produced is substantially isotactic polypropylene (iPP). The melt flow of the homopolymers produced using MS-1733 supported MCS ranged from about 13 to about 22 g/10 min. In comparison, the melt flow of polymer produced from G-948 and P-10 supported metallocene catalyst systems had a melt flow of less than about 10 g/10 min. The BD of polymer produced using MS-1733 support MCS are comparable to the bulk densities of polymer produced from G-948 and P-10 supported metallocene catalyst systems.

TABLE 3

| Support | MF (g/10 min) | BD (g/cc) |
|---|---|---|
| MS-1733 | ˜13 | ˜0.32 |
| MS-1733 | ˜22 | ˜0.31 |
| G-948 | ˜10 | ˜0.37 |
| G-948 | ˜9 | ˜0.38 |
| P-10 | ˜7 | ˜0.40 |

The preparation of the homopolymer of the present invention is repeated substantially as described hereinabove, with the following exceptions. Either about 20 or about 30 mg of either MS-1733 or P-10 supported MCS, in a ˜7.3% slurry in mineral oil, is combined with about 0.5 mmol TEA providing a TEA:MCS ratio of about 2:1 to about 3:1. The first reaction phase is carried out in bulk phase at about 70° C. for about 20 to 45 minutes in the presence of about 0.07 mol % H₂.

Following the bulk phase polymerization carried out as above described, the resulting homopolymer matrix is further polymerized with ethylene to produce a heterophasic copolymer, such further polymerization being in a gas phase step or zone. The gas phase step is conducted in the same reaction vessel as the bulk phase reaction, at about 75° C. for about 35 to 45 minutes. Monomers, comprising ethylene and propylene gas are introduced at a flow rate of about 6 L/min to about 10 L/min, with E:P ratios of about 50:50. A 2 L stainless steel sample cylinder containing 13× molecular sieves is placed in-line before the reactor to purify the monomers. The reactor's pressure is maintained at about 80 psi (−550 kPa) via a back pressure regulator. H₂ gas is supplied at rates ranging from about 0 to about 80 cc/min.

The total ethylene content of the ICP (E wt %) is determined using conventional IR measurements (or NMR measurements, shown in parenthesis). The total weight fraction of heterophasic polymer soluble in Xylene expressed as a percent Xylene solubles(XS %) is determined using conventional techniques. Melt flow and bulk density are measured as described above. The flowability of the heterophasic polymer is assessed by measuring the weight of heterophasic polymer passing through a funnel over time in accordance with ASTM D 1895-96:Standard Test Methods for Apparent Density, Bulk Factor, and Pourability of Plastic Materials, and is expressed as grams per second. This procedure for determining flowability is conducted at room temperature under ambient humidity. The apparatus used is a conical funnel 230 mm in height with a top opening of 127 mm and bottom opening of 25.4 mm. The bottom of the funnel is sealed with an ungloved hand and the sample of polymer fluff is added to the funnel gently through the top opening. For testing, the amount of polymer used ranged from 36 to 160 grams. Where possible, 160 grams are used. The bottom of the funnel is opened and a timer started at the same instant. The polymer is allowed to flow freely (without agitation to the fluff or funnel) from the funnel by gravity. The timer is stopped at the instant the last polymer fluff leaves the funnel. Results are reported as total grams of polymer per unit time of flow. At least 5 repeat measurements are taken and the reported result is the average of these 5 measurements. [0073] For selected samples of ICP prepared using MS-1733 or P-10 supported MCS, conventional Differential Scanning Calorimetry instrumental and techniques (DSC) are used to measure the ICP's melting temperature and heat of melting (Tm and Hm, respectively), and recrystallization temperature and heat of recrystallization (Tr and Hr, respectively).

TABLE 4 below presents selected results characterizing the ethylene content of representative ICP produced from two phase polymerization reactions catalyzed by MS-1733 or P-10 supported MCSs. Xylene soluble percent is thought to provide a measure of the rubber content of the ICP, because the metallocene catalyzed production of PP results in virtually no atactic PP, and iPP is not soluble in Xylene. The XS % therefore suggests that substantial portions of rubber are incorporated into the ICP. The Xylene soluble percentage is determined in accordance with ASTM D 5492-98:Standard Test Method for Determination of Xylene Solubles in Propylene Plastics. Likewise, the ethylene wt % is thought to represent the ethylene content of the rubber fraction because there is substantially no ethylene present in the homopolymer, i.e., less than about 0.1%. For example, in one of the illustrations of TABLE 4, 100 g of ICP prepared using an MCS supported by MS-1733, would contain about 12.8 g of rubber, about 4 g of which corresponds to ethylene. Thus the ethylene content of the rubber fraction equals about 33%.

TABLE 4

| Support | E (wt %) | XS (%) |
|---|---|---|
| MS-1733 | ˜2 | ˜4.9 |
| MS-1733 | ˜2 | ˜5.6 |
| MS-1733 | ˜2 | ˜9.3 |
| MS-1733 | ˜3.7 (˜4.0) | ˜12.8 |
| P-10 | ˜1 | ˜3.8 |
| P-10 | ˜2 | ˜5.8 |
| P-10 | ˜3.2 | ˜8.7 |
| P-10 | (˜5.0) | ˜14.7 |

TABLE 5 presents results characterizing certain properties of representative heterophasic polymers produced from a bulk phase polymerization followed by a gas phase polymerization reactions catalyzed by MS-1733 or P-10 supported MCSs and as hereinabove described. Particularly noteworthy is the flowability of heterophasic polymers having a range of Xylene solubles compounds made using MS-1733 support MCS, versus the P-10 support. Using the MS-1773 support resulted in heterophasic copolymers have an average flowability of 60.6±1.9 g/s (determined as above described) over a range of Xylene solubles contents from about 0.5 to about 10%. In contrast, over a comparable range of Xylene soluble content the P-10 supports resulted in an average flowability of 75.0±11.3. Thus, for similar levels of Xylene solubles, the MS-1733 supported catalyst produces ICP that has a greater flowablity than for heterophasic copolymer produced using P-10 supported catalysts.

The flowability test shows that as rubber is incorporated into the P10-based mICP, the flowability decreases rapidly indicating that the rubber is blooming to the surface and interfering with fluff transfer properties. In marked contrast, the flowability of “mICP” from MS1733 is less impacted with incorporating rubber and consequently the flowability remains largely unchanged for moderate levels of rubber incorporation.

TABLE 5

| Support | XS (%) | flowability (g/s) |
|---|---|---|
| MS-1733 | ˜0.5 | ˜58.5 |
| MS-1733 | ˜1.9 | ˜59.3 |
| MS-1733 | ˜4.9 | ˜63.3 |
| MS-1733 | ˜5.6 | ˜59.3 |
| MS-1733 | ˜9.3 | ˜60.7 |
| MS-1733 | ˜12.8 | ˜18.7 |
| P-10 | ˜0.5 | ˜91.5 |
| P-10 | ˜2.7 | ˜72.3 |
| P-10 | ˜3.8 | ˜70.5 |
| P-10 | ˜5.8 | ˜66.0 |
| P-10 | ˜11.6 | ˜40.2 |

The DSC analysis of heterophasic copolymer samples produced from MS-1733 support MCSs revealed Tm ranging from about 149 to about 152° C., AHm ranging from about 74 to about 89 J/g, Tr ranging from about 98 to about 102° C. and ΔHr ranging from about 76 to about 93 J/g. Heterophasic copolymer produced from P-10 support MCS had Tm ranging from about 149 to about 150° C., AHm ranging from about 79 to about 90 J/g, Tr ranging from about 103 to about 106° C. and AHr ranging from about 80 to about 89 J/g.

Although the present invention has been described in detail, those skilled in the art should understand that they can make various changes, substitutions and alterations herein without departing from the scope of the invention.

1. A heterophasic polymer having a flowability value within the range of from about 20 to about 80 grams per second.

2. The heterophasic polymer of claim 1 wherein the heterophasic polymer is produced using a supported metallocene catalyst system.

3. The heterophasic polymer of claim 1 wherein the heterophasic polymer has a xylene soluble content of not greater than 15 weight percent.

4. The heterophasic polymer of claim 1 wherein the heterophasic polymer is a copolymer comprising a homopolymer matrix and an ethylene/propylene copolymer.

5. The heterophasic polymer of claim 2 wherein the supported metallocene catalyst is supported upon a silica support.

6. The heterophasic polymer of claim 5 wherein the silica support is further defined as having an average pore volume of from about 1 to about 3.5 ml/g and an average surface area of at least 273 m²/g.

7. The heterophasic polymer of claim 1 wherein the heterophasic polymer is produced in two reaction zones, a first reaction zone comprising a bulk phase polymerization followed by a second reaction zone comprising a gas phase polymerization zone.

8. The heterophasic polymer of claim 7 wherein an olefin selected from the group consisting of ethylene and an alpha olefin monomer of 3 to 12 carbon atoms is polymerized in such first reaction zone to produce a homopolymer of the monomer and wherein such homopolymer is further polymerized in second reaction zone in the presence of ethylene/propylene.

9. The heterophasic polymer of claim 2 wherein the supported metallocene catalyst system has incorporated therein an activator.

10. A catalyst system for producing a heterophasic polymer comprising
a supported metallocene catalyst capable of producing a heterophasic polymer having a flowability value within the range of from about 20 to about 80 grams per second.

11. The catalyst system of claim 10 wherein the metallocene catalyst is supported by a silica support.

12. The catalyst system of claim 10 wherein the heterophasic polymer has a xylene soluble of no greater than 15.0 weight percent.

13. The catalyst system of claim 11 wherein the silica support is further defined as having an average pore volume of from about 1 to about 3.5 ml/g and an average surface area of at least 273 m²/g.

14. The catalyst system of claim 11 wherein the silica support is further defined as having pores therein and wherein such pores have pore diameters within the range of 240 to 360 Angstroms.

15. The catalyst system of claim 10 wherein the supported metallocene catalyst contains an activator.

16. The catalyst system of claim 15 wherein the supported metallocene catalyst contains MAO as the activator.

17. The catalyst system of claim 10 wherein the heterophasic polymer comprises a homopolymer matrix produced in a first reaction zone and a rubber comprising ethylene and propylene produced in a second reaction zone.

18. The catalyst system of claim 11 wherein the amount of silica support within the supported metallocene catalyst system is within the range of 52 to 68 wt % of the supported metallocene catalyst system.

19. A method of producing a heterophasic polymer having a flowability value within the range of from about 20 to about 80 grams per second, comprising (a) introducing a quantity of a first olefin monomer into a first polymerization reaction zone in the presence of a supported metallocene catalyst system and (b) introducing the product of step (a) into a second polymerization reaction zone in the presence of a supported metallocene catalyst system and in the presence a quantity of a first olefin monomer and a quantity of a second olefin monomer.

20. The method of claim 19 wherein the heterophasic polymer has a xylene soluble content of no greater than 15 weight percent.

21. The method of claim 19 wherein the first reaction zone comprises a bulk phase reaction zone and wherein the second reaction zone comprises a gas phase reaction zone.

22. The method of claim 19 wherein the supported metallocene catalyst system includes silica as the support.

23. The method of claim 22 wherein the silica support is further defined as having an average pore volume of at least 1.51 ml/g and an average surface area of at least 273 m²/g with pore diameters within the range of 240 to 440 Angstroms.

24. The method of claim 19 wherein the supported metallocene catalyst system of each of the first and the second reaction zones, are the same.

25. The method of claim 19 wherein the heterophasic polymer comprises a homopolymer phase produced in the first reaction zone and a rubber phase produced and distributed upon the homopolymer, in the second reaction zone.

26. The method of claim 21 wherein the silica supported metallocene catalyst system includes an activator.

27. The method of claim 26 wherein the activator is MAO.

28. The method of preparing a supported metallocene catalyst system capable of producing a heterophasic polymer having a flowability value within the range of from about 20 to 80 g/second, comprising: (a) impregnating a silica support with an activator; and b) using the activator impregnated support to support a metallocene catalyst.

29. The method of claim 28 wherein the supported metallocene catalyst system includes silica as the support.

30. The method of claim 29 wherein the silica support is further defined as having an average pore volume of at least 1.51 ml/g and an average surface area of at least 273 m²/g with pore diameters within the range of 240 to 440 Angstroms.

31. The method of claim 28 wherein the activator is MAO.

32. The method of claim 28 wherein the metallocene is one selected from the group consisting of a substituted C₂-symmetric racemic silanediyl-bridged bisindenyl zirconium dichloride and a substituted C₁-symmetric methylene-bridged cyclopentadienyl fluorenyl zirconium dichloride.

33. The method of claim 32 wherein the metallocene catalyst is one selected from the group consisting of a substituted racemic silanediyl-bridged bisindenyl zirconium dichloride.

34. The method of claim 33 wherein the metallocene catalyst is a substituted methylene-bridged cyclopentadienyl fluorenyl zirconium dichloride.

35. The method of claim 28 wherein the silica support has pores of 240 to 440 Angstroms in diameter.

36. The method of claim 19 wherein the method is applied to a production scale polymerization line.
